(19) United States
(12) Patent Application Publication
(10) Pub. No.: US 2026/0276592 A1
(43) Pub. Date: Sep. 17, 2026

(54) MATRIX CAPTURE APPROACH FOR EDDY CURRENT (EC) INSPECTION

(71) Applicant: Evident Canada, Inc., Québec (CA)

(72) Inventor: Benoit Lepage, L'Ancienne-Lorette (CA)

(21) Appl. No.: 19/168,668

(22) PCT Filed: Mar. 29, 2024
(86) PCT No.: PCT/CA2024/050416

§ 371 Date: Sep. 24, 2025

Related U.S. Application Data
(60) Provisional application No. 63/493,308, filed on Mar. 30, 2023.

(51) Int. Cl. G01N 27/904; G01N 27/90

(52) U.S. Cl. CPC G01N 27/904; G01N 27/9006; G01N 27/9053

(57) ABSTRACT

A machine-implemented technique as described herein can include construction of eddy current sensor measurements using a matrix capture acquisition approach applied to data obtained using an eddy current array (ECA) probe. Such measurements can be established or selected to provide EC inspection results for coverage of different flaw orientations, such as providing firmware or software configurability of detection orientation. Use of a matrix capture approach can also be used to perform lift-off sensing and associated compensation without requiring use of a separate lift-off sensing element. A matrix capture approach allows for inspection and lift-off sensing modalities that differ from the physical arrangement of sensors used for performing the acquisition, such as providing inspection results corresponding to novel sensor constructions.

### CLAIM OF PRIORITY

This patent application claims the benefit of priority of Lepage, U.S. Provisional Patent Application No. 63/493,308, titled “EDDY CURRENT SENSOR CONSTRUCTION USING FULL MATRIX CAPTURE (FMC) APPROACH,” filed on Mar. 30, 2023 (Attorney Docket No. 6409.246PRV), which is hereby incorporated by reference herein in its entirety.

### FIELD OF THE DISCLOSURE

This document pertains generally, but not by way of limitation, to apparatus and techniques for non-destructive inspection such as facilitating eddy current inspection, and more particularly, to apparatus and techniques for construction of eddy current sensor representations using a matrix capture acquisition approach applied to data obtained using an eddy current array (ECA) probe.

### BACKGROUND

Non-destructive testing (NDT) can refer to use of one or more different techniques to inspect regions on or within an object, such as to ascertain whether flaws or defects exist, or to otherwise characterize the object being inspected. One class of non-destructive testing can include use of an eddy current testing approach where electromagnetic energy is applied to the object and resulting induced currents on or within the object are detected, with the values of a detected current (or a related impedance) providing an indication of the structure of the object under test, such as to indicate a presence of a crack, scratch, void, porosity, or other inhomogeneity (e.g., corrosion or pitting). Generally, an eddy current (EC) sensor includes one or more sensor elements such as inductive coils that can be excited using an alternating current (AC) source. Such coils (or other electromagnetic sensing elements such as hall sensors) can be used for receiving a signal indicative of an induced eddy current on or within the structure in response to such excitation, using either the same coil for both excitation and pickup (e.g., connected through a bridge circuit), or using one coil for transmission and another coil for pickup. Generally, whether single-sensor eddy current testing (ECT) or multi-sensor eddy current array (ECA) configurations are used, the sensor configuration is physically defined and fixed at fabrication, not only in terms of physical geometry and arrangement of the coil elements, but also by the available interconnections between the coil elements and measurement instrument drive (e.g., transmitter) and pickup (e.g., receiver) channels. Accordingly, measurement modes and characteristics of generally available sensors may be limited in terms of sensitivity to certain flaw orientations or in terms of available modes for excitation and pickup.

### SUMMARY OF THE DISCLOSURE

In existing approaches, a physical configuration and orientation of an eddy current sensor, such as a coil or array of coils, generally determines performance characteristics such as sensitivity to flaw orientation or lift-off. The present inventor has recognized, among other things, that such limitations may make certain sensor configurations less effective at detection of certain kinds of flaws, such as in situations where a structure being inspected has an irregular surface or unknown flaw orientation. Because certain sensor configurations may result in an inability to detect certain flaw orientations, use of existing approaches may require multiple scan passes where an EC sensor or array of such sensors is placed in different orientations to be sure that desired coverage is achieved.

As an illustration, a differential sensor can be formed using two coils connected to a differential amplifier input in such a way as to null a residual output to indicate a flawless part condition. However, a differential signal indication can be synthesized in other ways. Assuming linear sensor behavior, two complex-valued measurements corresponding to each sensor in the differential pair can be made individually, and a difference can be determined later during analysis, providing a result that is equivalent to a direct analog differential measurement. The present inventor has recognized, among other things, that a concept of linearly combining measurements corresponding to different transmit/receive pairs can be expanded to more than forming a differential sensor synthetically. Linearly combining measurements from more than two sensors allows a very broad range of synthetic sensor configurations to be generated and used for eddy current testing, such as providing configurable selectivity for sensing different flaw orientations without requiring physically re-orienting a sensor assembly during inspection. The present inventor has also recognized that such an approach can also be used to perform lift-off sensing (LOS) and corresponding lift-off compensation (LOC).

A desired synthetic sensor configuration need not be specified a priori. For example, acquisition of measurements can be performed using some or all different permutations of transmit/receive pairs of sensors. Such an acquisition approach can be referred to as a matrix capture approach, where full matrix capture refers to acquisition of all different permutations of transmit/receive pairs of sensors. Parallel acquisition can enhance acquisition efficiency where multiple receiver channels are available (e.g., supporting transmission from one sensor contemporaneously while receiving signals from multiple other sensors contemporaneously, or even the same sensor as the transmitter with use of an impedance measurement mode such as implemented using a bridge circuit). After matrix capture, subsequent analysis can be performed by adjusting one or more sensor weights (referred to herein as gain values) or other parameters and performing a summation (e.g., a linear combination) of different acquired measurements to achieve a specified synthetic sensor configuration. For example, an angular skew parameter can be selected to form a synthetic sensor that is sensitive to flaws in longitudinal or transverse (L-T) orientations relative to the physical sensor array, or sensitive to a specified oblique angle. A series of such summations can provide coverage during post-acquisition analysis for a variety of different potential flaw orientations without requiring physical re-scanning with different sensor orientations.

In an example, a machine-implemented method for performing an eddy current measurement using matrix capture can include, for elements in an eddy current array (ECA) sensor, generating an excitation signal and routing the excitation signal to a selected transmit element amongst the elements and receiving and digitizing eddy current measurements from respective receive elements from amongst the elements in response to the excitation signal. The machine-implemented method can include constructing a synthetic measurement by aggregating received eddy current measurements for different transmit-receive pairs of elements including applying gain factors based on a transmit element index and a receive element index. The respective gain factors can comprise a product of a gain factor corresponding to the transmit element index and a gain factor corresponding to the receive element index. In another approach (e.g., for lift-off sensing), the respective gain factors can be defined uniquely based on both the transmit element index and the receive element index.

A system for performing an eddy current measurement using matrix capture can include a transmitter circuit configured to generate an excitation signal, a receiver circuit configured to receive an eddy current measurement, a multiplexer configured to selectively route the excitation signal to a selected sensor in an eddy current array (ECA) sensor, a processor circuit communicatively coupled with the transmitter circuit, the receiver circuit, and the multiplexer circuit, and a memory circuit communicatively coupled with the processor circuit, the memory circuit comprising instructions that, when executed by the processor circuit, cause the system to perform the a machine-implemented method as mentioned in the examples above or as described elsewhere herein.

This summary is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally an example comprising a non-destructive inspection system, such as can be used to perform at least a portion one or more techniques as shown and described herein.

FIG. 2 shows an illustrative example of a planar cross-wound sensor (CWS) eddy current array, such as can be fabricated using a rigid or flexible printed circuit assembly having two metallization layers.

FIG. 3 shows an illustrative example of a bridge circuit, such as can be used for acquisition of eddy current measurements when the same coil element is used both as a transmitter and as a receiver.

FIG. 4A and FIG. 4B show illustrative examples of summations of imaginary parts of measured eddy current signals acquired using a matrix capture approach, where different normalization factors are used to weight measurements in the summation acquired using a bridge configuration versus separate transmit and receive sensors.

FIG. 5 shows an illustrative example of two different measurement sensor orientations and an associated steel test object having notches extending to four different depths.

FIG. 6 shows an illustrative example of a graphical representation of vertical (e.g., imaginary part) amplitudes versus time for different angular skew parameter (e.g., P) values, where scans are performed on the steel test object as shown in FIG. 5 for different physical measurement sensor orientation (e.g., 0) values.

FIG. 7A shows designations for different elements in a CWS array configuration and FIG. 7B shows corresponding gain values used for establishing a lift-off sensing channel from an eddy current matrix capture (ECMC) acquisition.

FIG. 7C shows an illustrative example of summed values plotted parametrically in an impedance plane view where summation is performed using the gain values of FIG. 7B, showing that a lifted-off acquisition trace still indicates the flaw in a direction orthogonal to the remainder of the scan trace in the impedance plane.

FIG. 8A shows an illustrative example of normalized vertical amplitude values without lift-off compensation for different lift-off heights used for scanning a notch in a test sample, and FIG. 8B shows an illustrative example of normalized vertical amplitude values where lift-off compensation is applied using the synthetic lift off sensors established using gain values shown in FIG. 7B, and as discussed above.

FIG. 8A shows an illustrative example of normalized vertical amplitude values without lift-off compensation for different lift-off heights used for scanning a notch in a test sample, and FIG. 8B shows an illustrative example of normalized vertical amplitude values where lift-off compensation is applied using the synthetic lift off sensors established using gain values shown in FIG. 7B, and as discussed above.

FIG. 9 illustrates generally a technique, such as a machine-implemented method, comprising:

FIG. 10 illustrates a block diagram of an example comprising a machine upon which any one or more of the techniques (e.g., methodologies) discussed herein may be performed.

### DETAILED DESCRIPTION

A machine-implemented technique as described herein can include construction of eddy current sensor measurements using a matrix capture acquisition approach applied to data obtained using an eddy current array (ECA) probe. Such measurements can be used to synthesize EC inspection results for coverage of different flaw orientations, such as providing firmware or software configurability of detection orientation, including varying such configuration during post-analysis of previously-acquired eddy current matrix capture (ECMC) measurement data. Use of a matrix capture approach can also (or instead) be used to perform lift-off sensing and associated compensation without requiring a physically separate lift-off sensor. A matrix capture approach allows for inspection and lift-off sensing modalities that differ from the physical arrangement of sensors used for performing the acquisition, with a synthetic sensor configuration that can be manipulated without requiring re-acquisition of measurement data. The approaches described herein can also provide measurement or lift-off sensing modalities corresponding to novel sensor constructions, including digitally aggregating measurements from a matrix capture acquisition in ways that would not otherwise be achievable using physical sensors and analog aggregation of acquired signals.

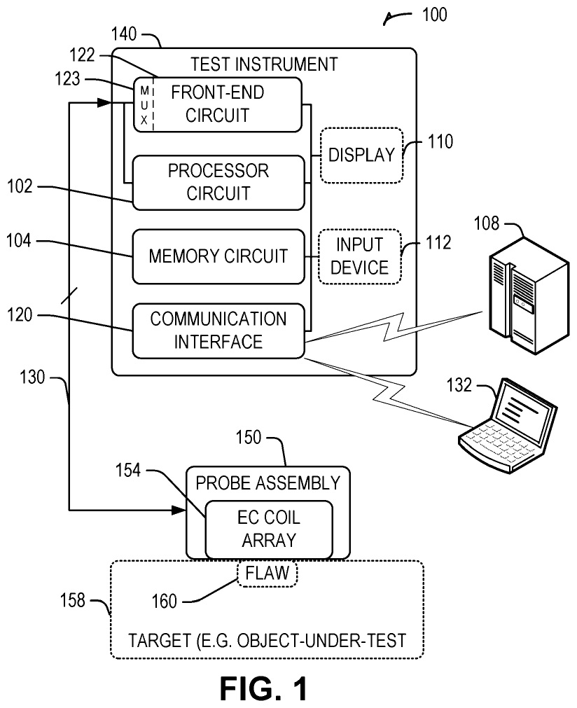

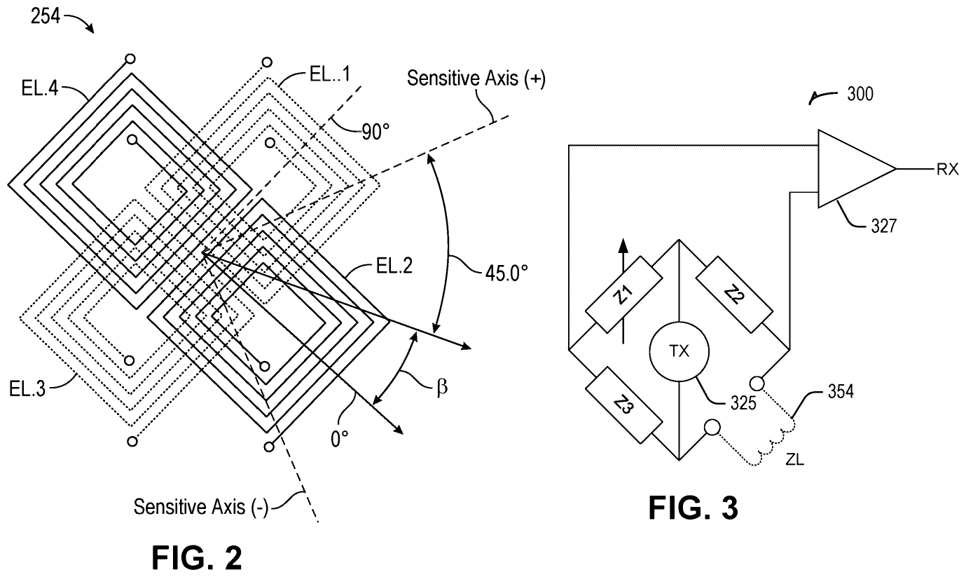

FIG. 1 illustrates generally an example comprising a non-destructive inspection system 100, such as can be used to perform at least a portion one or more techniques as shown and described herein. The non-destructive inspection system 100 can include a test instrument 140, such as a hand-held or portable assembly. The test instrument 140 can be electrically coupled to a probe assembly 150, such as using a multi-conductor interconnect 130. The probe assembly 150 can include one or more sensors, such as an eddy current coil array 154 (ECA). The EC coils are electromagnetically coupled with a target 158 (e.g., a test specimen or “object-under-test”) and the system 100 can be used to detect a flaw 160 using one or more techniques shown and described in this document. The ECA 154 can be a four-coil planar cross-wound sensor (CWS) as shown and described in relation to various examples herein, such as below in FIG. 2. Use of the CWS of FIG. 2 is merely illustrative, and other sensor configurations (having more or less than four coil elements) can be used. The ECA 154 can be flexible or can otherwise follow a linear or curved contour or can include an array of elements extending in multiple axes. Element size and pitch can be varied according to the inspection application.

A modular probe assembly 150 configuration can be used, such as to allow a test instrument 140 to be used with various different probe assemblies. The test instrument 140 can include digital and analog circuitry, such as a front-end circuit 122 including one or more transmit signal chains (forming a transmitter circuit), receive signal chains (forming a receiver circuit), or switching circuitry (e.g., a multiplexer circuit 123). The transmit signal chain can include amplifier and filter circuitry, such as to provide an alternating current (AC) excitation signal for delivery through an interconnect 130 to a probe assembly 150. The front-end circuit 122 can be controlled to perform a matrix capture acquisition approach as shown and described elsewhere herein.

While FIG. 1 shows a single probe assembly 150 and a single ECA 154, other configurations can be used, such as multiple probe assemblies connected to a single test instrument 140, or multiple arrays 154 used with a single probe assembly 150. Similarly, a test protocol can be performed using coordination between multiple test instruments 140, such as in response to an overall test scheme established from a respective test instrument 140 or established by another remote system such as a compute facility 108 or general-purpose computing device such as a laptop 132, tablet, smart-phone, desktop computer, or the like. The test scheme may be established according to a published standard or regulatory requirement and may be performed upon initial fabrication or on a recurring basis for ongoing surveillance, as illustrative examples.

The front-end circuit 122 can be coupled to and controlled by one or more processor circuits, such as a processor circuit 102 included as a portion of the test instrument 140. The processor circuit can be coupled to a memory circuit 104, such as to execute instructions that cause the test instrument 140 to perform one or more of EC acquisition (e.g., a matrix capture acquisition), processing, or storage of data relating to an EC inspection, or to otherwise perform techniques as shown and described herein. The test instrument 140 can be communicatively coupled to other portions of the system 100, such as using a wired or wireless communication interface 120. Generally, as described elsewhere herein, an EC inspection can include establishing a synthetic sensor configuration from acquired matrix capture data.

Performance of one or more techniques as shown and described herein can be accomplished on-board the test instrument 140 or using other processing or storage facilities such as using a compute facility 108 or a general-purpose computing device such as a laptop 132, tablet, smart-phone, desktop computer, or the like. For example, processing tasks that would be undesirably slow if performed on-board the test instrument 140 or beyond the capabilities of the test instrument 140 can be performed remotely (e.g., on a separate system), such as in response to a request from the test instrument 140. The test instrument 140 can include a display 110, such as for presentation of configuration information or results, and an input device 112 such as including one or more of a keyboard, trackball, function keys or soft keys, mouse-interface, touch-screen, stylus, or the like, for receiving operator commands, configuration information, or responses to queries.

As shown and described herein, acquired eddy current measurement signals (e.g., complex-valued time-series measurements, or complex-valued measurements including received signal values associated with encoded position or other synchronization information) from different transmit/receive combinations of sensors can be linearly combined, such as using a summation, in view of a linearity and superposition assumptions. A matrix capture approach can be used where some or all possible permutations of different transmit/receive combinations can be acquired to provide data set in manner similar to Full Matrix Capture (FMC) in the acoustic inspection context. Use of eddy current matrix capture (ECMC) as shown and described herein does not require knowledge of propagation path time delays unlike acoustic inspection beamforming approaches such as Total Focusing Method. Instead, as shown and described herein, the present inventor has recognized that element-specific or element-pair-specific gain values can be assigned, and a resulting synthetic sensor can be formed after acquisition by selecting such gain values or other parameters. The gain values can, but need not, be established in a physics-informed manner based on physical sensor geometry, allowing synthetic sensors to be synthesized during post-analysis that either correspond to a physical sensor configuration, or even non-physical sensor configurations (such as discussed below in relation to synthesis of a lift-off sensing approach). A complex-valued impedance plane measurement for such a synthetic sensor comprises aggregating (e.g., summing) values from respective individual transmit/receive pairs, as can be represented as shown below:

$${S}_{S} = {\sum }_{m = 1}^{M} {\sum }_{n = 1}^{N} {G}_{m} {G}_{n} {S}_{mn} \qquad EQN . ( 1 )$$

In equation (1), above, the complex-valued impedance plane measurement, S_{S}, represents a summation of individual measurements Sₘₙ, for a group of sensor elements (e.g., having a count of M transmitting elements and a count of N receiving elements) where corresponding element-specific gain values Gₘ, Gₙ are applied depending on indices {m,n} corresponding to a particular transmit/receive pair of sensor elements. For example, a transmit element index can be represented by m and a receive element index can be represented by n. As discussed below, such gain values can be established based on analysis of a physical configuration of a sensor array used for acquisition, or gain values applied in such a summation can be determined using other criteria (such as based empirical evaluation for use as a synthetic lift-off sensor, as described elsewhere herein). In practice, a matrix capture acquisition can include using a multiplexer (e.g., multiplexer circuit 123) to select a particular transmit/receive pair in an eddy current array, and an impedance plane or other measurement can be obtained. Then, the multiplexer state can be changed to perform measurement using another transmit/receive pair, and so on, in a serial manner. If multiple receiver amplifier channels are available, some or all other elements can be sampled contemporaneously (e.g., in parallel) with a transmission from a given transmitter element. As discussed below, an impedance measurement mode such as a bridge configuration can be used so that even the sensor being used for transmission can also be used as a receiver and sampled contemporaneously with other receiver channels. A rate at which individual transmit/receive acquisitions are made can short enough in duration such that position change of the ECA during scanning does not introduce unacceptable error. In this manner, respective measurements for different transmit/receive combinations used for a matrix capture summation can be treated as having been obtained contemporaneously from the same spatial location of the ECA assembly, even if not literally all sampled simultaneously.

FIG. 2 shows an illustrative example of a planar cross-wound sensor (CWS) eddy current array (ECA) 254, such as can be fabricated using a rigid or flexible printed circuit assembly having two metallization layers. The use of a four-coil configuration for the ECA 254 is merely illustrative, and the approaches described herein are believed applicable to other array configurations. The ECA 254 of FIG. 2 can be fabricated so that two coil elements (e.g., EL.1 and EL.2) are located on one metallization layer, and the other two elements (e.g., EL.3 and EL.4) are located on another metallization layer. Each coil element can include a port having two conductors, such as through which the coil element can be driven or connected to a receiver (or both contemporaneously if a bridge configuration is used). The arrangement of four coil elements as shown in FIG. 2 is illustrative but non-restrictive. For example, coil elements could be selected from amongst a larger count of elements in an array having more than four elements. See for example U.S. Pat. No. 8,816,680 (Lepage), as an example of an ECA configuration that can include more than four sensor coils, and from which four coils could be selected in a manner similar to the example of FIG. 2.

For the CWS ECA 254 shown in FIG. 2, relationships can be established set Gₘ and Gₙ corresponding in view of measurement contributions from respective coils to control sensitive axes (“+” and “−”) in relation to a skew angle parameter (β). The phrase “sensitive axis” refers to an orientation of a long dimension of an elongated flaw, such as a crack, that will be detectable by the sensor. Generally, for a CWS ECA 254, the sensitive axes are offset from R by plus-or-minus 45 degrees as shown in FIG. 2. As an illustration, in a measurement configuration where EL.2 and EL.4 are driven differentially, and EL.1 and EL.3 are used as pickups differentially, β=45 degrees, and the sensitive axes are aligned at 90 degrees and zero degrees. The following relationships can be applied in order to establish Gₘ and Gₙ, where \vec{I}ᵣₒₜ represents an equivalent current vector from linear superposition of orthogonal coils A and B carrying current I_{A} and I_{B} respectively:

$$\vert \vec{{I}_{rot}} \vert = \sqrt{{I}_{A}^{2} + {I}_{B}^{2}} \qquad EQN . ( 2 )$$

$${I}_{A} = \vert \vec{{I}_{rot}} \vert * sin β \qquad EQN . ( 3 )$$

$${I}_{B} = \vert \vec{{I}_{rot}} \vert * cos β \qquad EQN . ( 4 )$$

Generally, EQN. (2) assumes that the magnitude of \vec{I}ᵣₒₜ is constant, and EQN. (3) and EQN. (4) indicate that each of the respective current values, I_{A} and I_{B}, are set based on projections of their contributions relative to the angular skew parameter, β. Because a reciprocity assumption can be made in relation to coils used for transmission or reception, and the simplest CWS configuration has coils that are oriented orthogonally with respect to each other, another constraint can also be applied:

$${β}_{receiver} = β + 90 ° \qquad EQN . ( 5 )$$

Additional constraints can be applied to establish respective element gain factors, Gₘ and Gₙ, by observing that transmitters that are opposite each other should have the same gain factor magnitude but opposite sign and that, similarly, opposite receivers should have the same gain factor magnitude but opposite sign. For a four element CWS such as the ECA 254 of FIG. 2, such constraints can be expressed as notated below in EQN. (6) and EQN. (7), respectively:

$${I}_{A} ∝ {G}_{m = 1} = - {G}_{m = 3} ; {I}_{B} ∝ {G}_{m = 2} = - {G}_{m = 4} \qquad EQN . ( 6 )$$

$${G}_{n = 1} = - {G}_{n = 3} ; {G}_{n = 2} = - {G}_{n = 4} \qquad EQN . ( 7 )$$

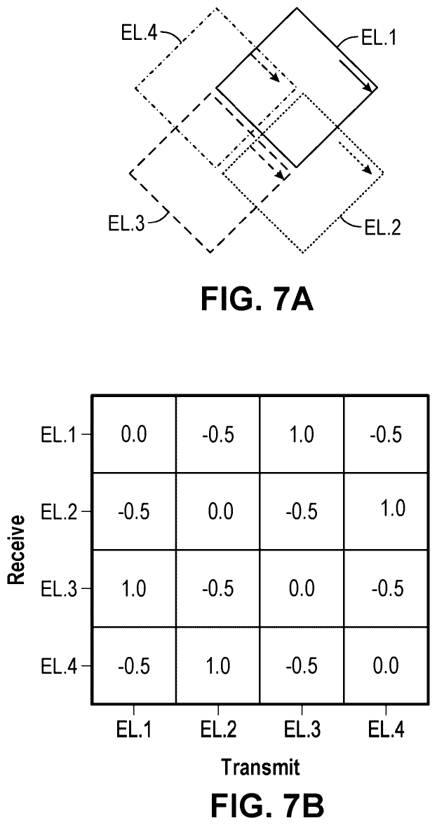

The following tables of transmit gain values (Gm) and receive gain values (Gn) can be used for specified § values (e.g., from −90 degrees to +90 degrees). These values conform to and are derived from the relationships mentioned above in relation to EQN. (2) through EQN. (7). In this manner, different summations can be performed using EQN. (1) above for different R values to obtain a synthetic sensor complex impedance plane measurement. A series of such summations can be done for matrix acquisitions corresponding to different time steps, as shown and described below in relation to the illustrative example of FIG. 6.

TABLE I
Transmit Coil Gain (Gₘ) Values for Summation

| EL.1 | EL.2 | EL.3 | EL.4 |
|---|---|---|---|
| (m = 1) | (m = 2) | (m = 3) | (m = 4) |
| sin(β) | cos(β) | −sin(β) | −cos(β) |

TABLE 2
Receive Coil Gain (Gₙ) Values for Summation

| EL.1 | EL.2 | EL.3 | EL.4 |
|---|---|---|---|
| (n = 1) | (n = 2) | (n = 3) | (n = 4) |
| −cos(β) | sin(β) | cos(β) | −sin(β) |

TABLE 3
Longitudinal/Transverse (L/T) Gain Value (GₘGₙ) Products for Summation

| GₘGₙ | T: EL.1 (m = 1) | EL.2 (m = 3) | T: EL.3 (m = 3) | T: EL.4 (m = 4) |
|---|---|---|---|---|
| R: EL.1 (n = 1) | −sin(β)*cos(β) | −cos²(β) | sin(β)*cos(β) | cos²(β) |
| R: EL.2 (n = 2) | sin²(β) | sin(β)*cos(β) | −sin²(β) | −sin(β)*cos(β) |
| R: EL.3 (n = 3) | sin(β)*cos(β) | cos²(β) | −sin(β)*cos(β) | −cos²(β) |
| R: EL.4 (n = 4) | −sin²(β) | −sin(β)*cos(β) | sin²(β) | sin(β)*cos(β) |

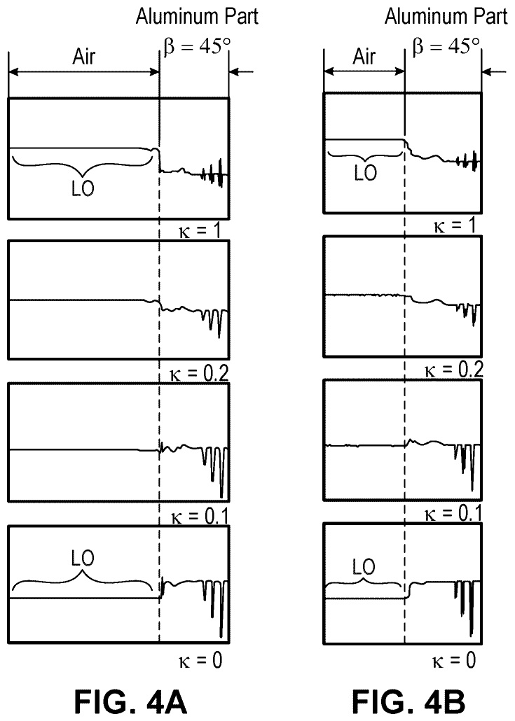

A “full” matrix acquisition can be defined as where an impedance plane measurement value (e.g., corresponding to a complex value Sₘₙ) is acquired for every gain value product in TABLE 3. Generally, as discussed above, when n≠m, a respective selected transmit coil is driven independently of the respective receive coil for a corresponding measurement. A challenge can exist with respect to the diagonal elements in the matrix of TABLE 3, where n=m, because the same coil is both driven and used for measurement. A bridge configuration can be used for both driving and receiving a signal from the same coil. For example, FIG. 3 shows an illustrative example of a simplified bridge circuit 300 configuration, for purposes of discussion. Generally, a respective sensor coil 354 is selected (e.g., one of EL.1, EL.2, EL.3, or EL.4 if a four-element CWS is used as shown in FIG. 2). A signal source 325 (e.g., “TX”) can drive two nodes in the bridge circuit 300. An amplifier circuit 327 (e.g., a differential amplifier) can be used to measure the other two nodes to detect any imbalance. A lock-in amplifier or other phase-coherent measurement technique (e.g., high-speed digitization and comparison of the TX signal and RX signal using a common time base) can be used so that both amplitude and phase information are measured. Before acquiring measurements, the bridge circuit 300 can be balanced, such as by nulling out any indication. One approach for balancing can include varying a reference impedance Z1 so that a ratio of Z1 to Z3 matches a ratio of Z2 to ZL in the absence of a flaw or lift off.

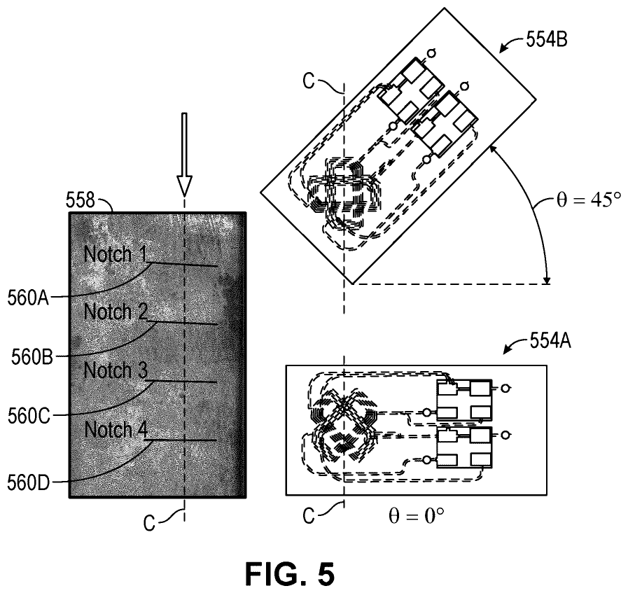

One or more reference impedances in the bridge circuit 300 (such as produced by a test coil or other structure) can impact the sensitivity of the bridge circuit 300, and the bridge circuit 300 would generally not be used in measurements where the transmit and receive coils are different. Accordingly, the present inventor has also recognized that a measurement sensitivity will differ between measurements where n=m (due to bridge sensitivity) versus where n≠m. This variation can be accounted for by applying a scaling ratio, K, which can be multiplied by the measurement Sₘₙ in the summation of EQN. 1, separately from the gain factors Gₘ and Gₙ, for terms in the summation where n=m (e.g., the diagonal elements in TABLE 3). As an illustrative example for the measurement configuration used for experimental data described herein, FIG. 4A and FIG. 4B show illustrative examples of summations of imaginary parts of measured eddy current signals acquired using a matrix capture approach, where different scaling factors (K values) are used to weight measurements in the summation acquired using a bridge configuration versus separate transmit and receive sensors. A nominal value for K will result in a sensitivity for bridge-configuration measurements (n=m) that is equivalent to a sensitivity for measurements where the transmit and receive sensors are different (n≠m).

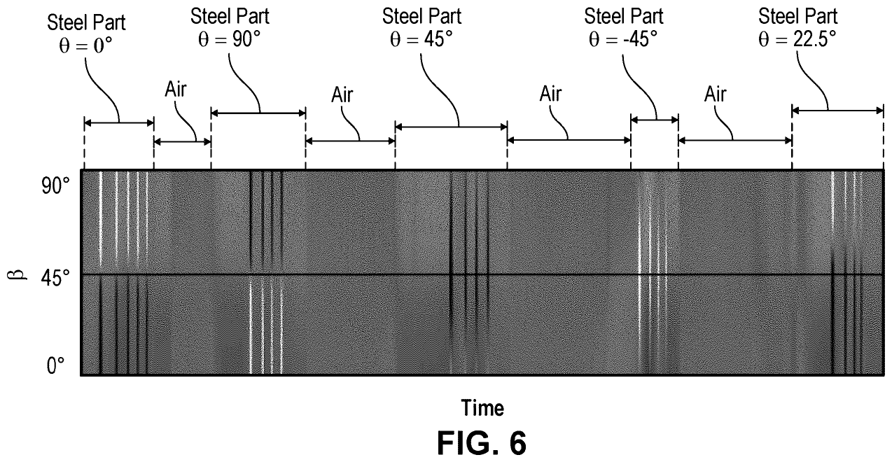

The plots shown in FIG. 4A and FIG. 4B are vertical amplitude channel strip chart representations and were obtained by summing measurements acquired by scanning a CWS ECA sensor 554B as shown in FIG. 5 across an aluminum sample with scribed notches, where a sensor skew angle (e.g., inclination as shown in the sensor 554B orientation of FIG. 5) is θ=45 degrees. For purposes of performing the summation, the skew angle parameter was also set to β=45 degrees. The summations were performed at each time sample in the strip chart (e.g., each point in the strip chart plot representing a value of an imaginary part of a summation result corresponding to a vertical direction in an impedance plane). Aluminum was used because it generally produces a strong lift off variation. For K value extremes (e.g., κ=0 or κ=1), a strong lift off indication occurs due primarily to mismatch in sensitivity between the bridge configuration and the other receive channels. Empirically, κ=0.1 appears to produce a summation where the sensitivity of the bridge measurement configuration and other channels is at least approximately equivalent, because in an idealized scenario, a perfect CWS configuration would not show any lift-off artifact. FIG. 4A used a measurement frequency of 500 kilohertz, and FIG. 4B used a measurement frequency of 1 megahertz. Similar results were obtained using a steel sample, indicating that the k values are likely dominated by sensor and bridge circuit configuration, rather than material or test frequency (at least within the range of frequencies used for evaluation).

The present inventor has recognized that another source of variation in output from summation can be caused by destructive interference effects in a physical sensor configuration. Accordingly, a global compensation factor can be determined and applied to the summation result. Such a compensation factor can be dependent on a parameter such as the angular skew parameter (β). For example, a transmitter gain compensation factor can be derived assuming superposition of flux contributions from respective coil elements, and can be represented by the expression below:

$${H}_{Transmit} ( β ) = \frac{1}{\vert \frac{sin β}{2} + \frac{cos β}{2} \vert + \vert \frac{cos β}{2} - \frac{sin β}{2} \vert} \qquad EQN . ( 8 )$$

As in other examples herein, a reciprocity assumption can be made, and the same compensation factor can be assumed for receiver behavior. Accordingly, a modified summation with the compensation factor can be represented as follows:

$${S}_{S} = {( \frac{1}{\vert \frac{sin β}{2} + \frac{cos β}{2} \vert + \vert \frac{cos β}{2} - \frac{sin β}{2} \vert} )}^{2} {\sum }_{m = 1}^{M} {\sum }_{n = 1}^{N} {G}_{m} {G}_{n} {S}_{mn} \qquad EQN . ( 9 )$$

FIG. 5 shows an illustrative example of two different measurement sensor orientations (showing inclination θ=0 degrees for a first sensor 554A orientation, and an inclination of θ=45 degrees for a second sensor 554B orientation) and an associated steel test object 558 having notches 560A, 560B, 560C, and 560D extending to four different depths. For the experimentally-obtained results in FIG. 6, below, a CWS sensor as shown in FIG. 5 was scanned mechanically across the test object 558 with a centerline axis, C, of the sensor assembly aligned with the dashed line as shown overlaying the test object 558, scanned in the direction indicated by the arrow. Several scan passes were made for different inclination angles, θ=0; 90; 45; −45; and 22.5 degrees. Such inclination angles are different from the angular skew values (P) used in performing summation, as discussed above. FIG. 6 shows an illustrative example of a graphical representation of vertical (e.g., imaginary part) amplitudes versus time for different angular skew parameter (e.g., β) values, where scans are performed on the steel test object as shown in FIG. 5 for the different physical measurement sensor orientation (e.g., θ) values as mentioned above.

The image in FIG. 6 is defined by a horizontal axis representing time, partitioned into different scan segments as labeled for the different physical inclination (θ) values, and the vertical axis is defined by different angular skew parameter (β) values (in 2-degree increments) used for summation, corresponding to synthetic CWS sensor orientations that are independent of the θ values. Each point in FIG. 6 represents a summation result corresponding to a respective time index, where rows of pixels in FIG. 6 correspond to a particular β value. A brightness of a respective pixel corresponds to a magnitude of the vertical signal component (e.g., imaginary part) of a summation result. The results in FIG. 6 correspond to expected behavior of a four-coil CWS configuration because negative signals appear when β=θ (represented as dark portions of the vertical stripes corresponding to the notches in the sample), and positive signals appear when β is offset from θ by plus-or-minus 90 degrees. The summations of FIG. 6 do not include the global compensation factor of EQN. (8), so some reduction in sensitivity is apparent near β=45 degrees, regardless of physical sensor orientation. Nonetheless, the results depicted in FIG. 6 validate that a matrix capture approach and summation reliably detects all four test sample notches for various physical sensor scan orientations, and notch orientation relative to scan orientation can be ascertained in part using vertical signal magnitude or through synthesize of a group of summations computed using different angular skew parameters. This indicates that all flaw orientations can be reliably detected from as few as a single scan pass having an arbitrary sensor orientation.

The examples discussed above do not generally involve lift off compensation or detection of a lift off condition. In one approach, lift off compensation (LOC) can be used in combination with a CWS coil configuration, such as by establishing a lift-off-dependent gain compensation factor. The dynamic gain factor can be established using a separate coil that senses lift off, but in such an approach, generally, a lift off sensing coil is physically separate from the CWS coils and spatially offset from a center of the CWS coil array. By contrast, the present inventor has recognized, among other things, that the matrix capture approach described herein can be used to synthesize a lift-off sensing (LOS) channel for use in lift-off detection or compensation, without requiring a physically separate lift off sensing coil.

The LOS channel can be synthesized from the same matrix capture acquisition as is used for other measurement summations, using a different gain matrix. A gain matrix used for synthesizing an LOS can be established based on various criteria. Such criteria can include that, in an impedance plane view, flaw indications in the lift-off sensor signal are orthogonal or produce only minute changes to a length of a vector originating from an indication produced by a sensor location far away from any surface (e.g., air) to the indication produced by a sensor location on the object under test. A behavior of such a vector is believed suitable for use as a lift-off sensor indication when the vector behavior corresponds to a relationship as shown below in EQN. (10), and candidate lift-off sensor gain matrices can be evaluated and compared to the relationship in EQN. (10) to evaluate suitability for use as a lift-off sensing indicium:

$$\vert \vec{{S}_{lift}} ( z ) \vert = \vert {S}_{lift} ( \vec{z} = 0 ) \vert {e}^{- {zb}_{lift}} \qquad EQN . ( 10 )$$

In EQN. (10), the magnitude of a summation used for determining the lift-off sensor magnitude is dependent on a lift-off height, z. A decay rate parameter b_{lift} can be fitted. The present inventor has also recognized, among other things, that instead of defining gain matrices as discussed above derived from physical principles associated with transmit coils or receive coils, and then computing gain products for transmit/receive coil combinations, specific transmit/receive pair gain values can be used that are unique to each transmit/receive pair. The form of the summation of EQN. (1) can be modified to provide a more generalized formulation:

$${S}_{S} = {\sum }_{m = 1}^{M} {\sum }_{n = 1}^{N} {G}_{mn} {S}_{mn} \qquad EQN . ( 11 )$$

Using this approach, individual gain values (Gmn) can be used corresponding to each {m,n} combination. A gain matrix for use in LOS can be formed based on empirical exploration, and in consideration of the criteria mentioned above. Another consideration can include reducing or minimizing temperature-dependent variation in the lift-off signal. One approach for establishing a gain matrix for use as an LOS can include omitting (e.g., zero-ing out or not including) contributions from the diagonal elements in the matrix in the synthetic sensor measurement summation, corresponding to measurements where the same sensor is used for both transmission and reception (where an impedance measurement is performed, such as using a bridge circuit). As an illustration, omitting the diagonal elements removes drift (e.g., temperature drift) associated with the bridge-based measurements corresponding to those diagonal elements.

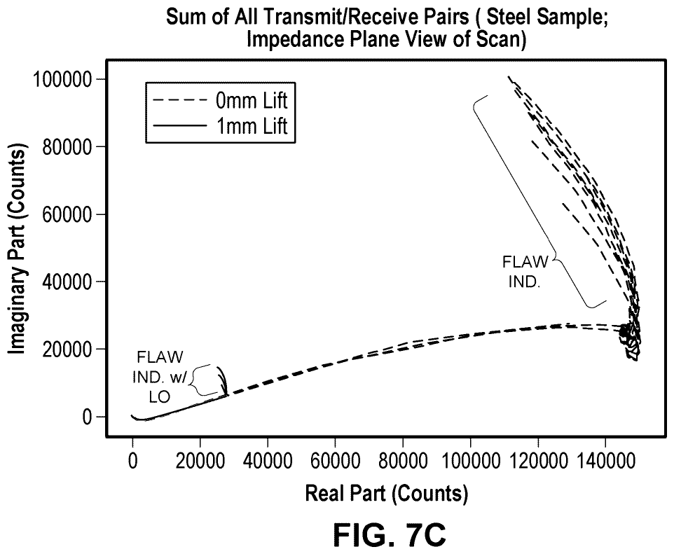

FIG. 7A shows designations for different elements in a CWS array configuration and FIG. 7B shows corresponding gain values used for establishing a lift-off sensing channel from an eddy current matrix capture (ECMC) acquisition. FIG. 7C shows an illustrative example of summed values plotted parametrically in an impedance plane view where summation is performed using the gain values of FIG. 7B, showing that a lifted-off acquisition trace still indicates the flaw in a direction orthogonal to the remainder of the scan trace in the impedance plane.

As an illustration, a four-coil CWS is shown in FIG. 7A, with coil elements labeled as EL. 1, EL.2, EL.3, and EL.4. FIG. 7B shows a corresponding matrix of Gmn that can be used in a summation having the form shown in EQN. (11). As shown in FIG. 7C, a balanced combination of nearby and far-away coil sensors used for the gain matrix in FIG. 7B provides flaw signals that are orthogonal to the lift-off signal as indicated by the 1-millimeter lift-off condition overlapping in the horizontal direction with the trace corresponding to the 0-millimeter lift-off condition, with flaw indications extending outward from both the 1-millimeter trace and the 0-millimeter trace as “legs” extending upward. The signal values shown in FIG. 7C in the impedance plane can be used to scale other Sₛ summation values, such as by taking a ratio of a CWS measurement (such as determined using EQN. (9) with corresponding gain values from TABLE 3 for a desired angular skew parameter value P) and dividing it by a magnitude of a lift-off sensor (LOS) channel summation, along with a decay rate compensation term (exponential with argument −b_{corr} as shown below in in the Dynamic Lift-Off Compensated (DLOC) measurement S_{DLOC} defined in EQN. (12).

$${S}_{DLOC} = γ \frac{{S}_{CWS} ( z )}{\vert \vec{{S}_{lift}} ( z ) \vert {e}^{- {b}_{corr}}} \qquad EQN . ( 12 )$$

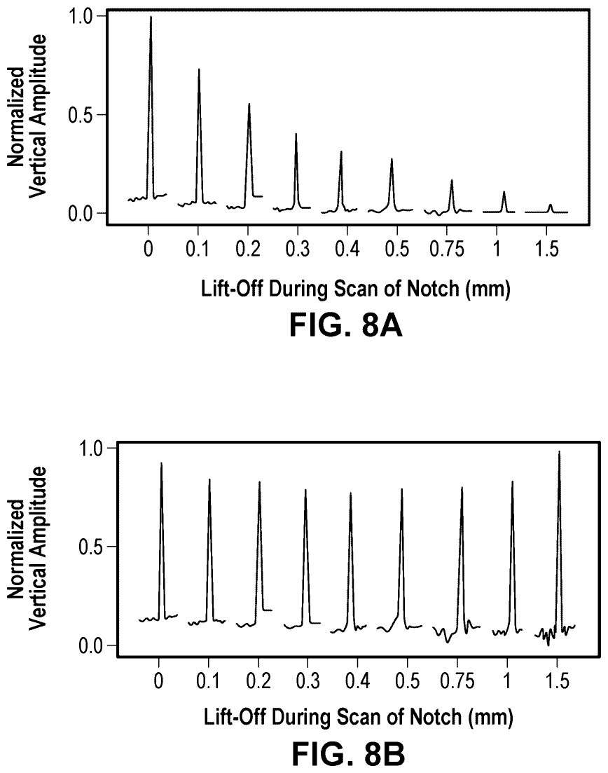

A suitable value for b_{corr} can be identified such as by observing a relationship between lift-off vector length in the impedance plane along with flaw amplitude decay rates versus lift-off height. For example, FIG. 8A shows an illustrative example of normalized vertical amplitude values without lift-off compensation for different lift-off heights used for scanning a notch in a test sample using the matrix capture and summation approach discussed above, and FIG. 8B shows an illustrative example of normalized vertical amplitude values where lift-off compensation is applied using the synthetic lift off sensor established using gain values shown in FIG. 7B, and as discussed above. Measurement conditions for obtaining the vertical amplitudes in FIG. 8A and lift-off-compensated values in FIG. 8B included measurement of Notch 4 in the sample shown in FIG. 5, with β=θ=0 degrees, and lift-off values ranging from 0 mm to 1.5 mm at a 500 kHz test frequency. Amplitude was normalized through use of a suitable y value to obtain an absolute amplitude of 1.0 on Notch 4 at 0 mm lift-off. The decay rate adjustment factor b_{corr} was set based on empirical observation to 1.43 to optimize sensor operation in the 0-to-1-mm lift-off range.

In FIG. 8A, an amplitude loss of about −27 dB occurs due to lift-off, relative to the 0-mm reference condition. Application of dynamic lift-off compensation as described above reduced such amplitude variation to within a range of 2.6 dB. Other LOS gain matrices can be defined, such as evaluated across different frequencies, materials, or surface conditions.

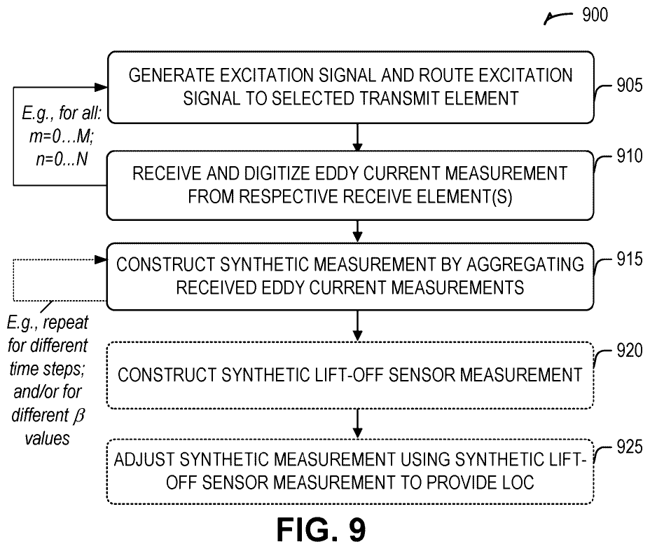

FIG. 9 illustrates generally a technique 900, such as a machine-implemented method, comprising. At 905, generating an excitation signal and routing the excitation signal to a selected transmit element, such as in an eddy current array (ECA) sensor. At 910, an eddy current measurement can be obtained, such as by receiving and digitizing a signal detected at a respective receive element (or multiple elements if multiple receiver channels are available). The measurement can include amplitude and phase data relative to the excitation signal. Operations at 905 and 910 can be repeated for all available transmit-receive permutations of elements in the ECA sensor, such as to can be referred to as performing a “full” matrix capture acquisition (loop through all possible {m,n} permutations). This can include permutations where the same element is used as both a transmit element and a receive element, as discussed elsewhere herein. At 915, a synthetic sensor measurement (such as a complex-valued measurement datum) can be constructed, such as using a summation of respective received eddy current measurements with corresponding gain factors applied as discussed elsewhere herein. Determining a synthetic sensor measurement at 951 can include determining a series of measurements using various skew angle parameters (e.g., to provide sensitivity for different flaw orientations as discussed above).

Optionally, at 920, a synthetic lift-off sensor measurement can be constructed. The same matrix capture acquisition can be used for both construction of a synthetic measurement at 915 and for construction of a synthetic lift-off sensor measurement at 920. At 925, the synthetic measurement (or measurements) constructed at 915 can be adjusted such as to perform lift-off compensation (LOC) in a dynamic manner as shown and described elsewhere herein. Other compensation can be performed. For example, optionally, a global compensation can be applied to the synthetic measurement constructed at 915, such as based on an angular skew parameter dependency as discussed elsewhere herein. A resulting synthetic measurement constructed at 915 (either lift-off compensated or uncompensated) can be presented, such as in an impedance plane, or strip-chart view of scalar values (such as corresponding to vertical amplitude values from an impedance plane). Alternatively, or in addition, matrix capture acquisition data, such as time-series data, can be logged or archived, and synthetic measurements can be constructed at a later time based on specified analysis parameters.

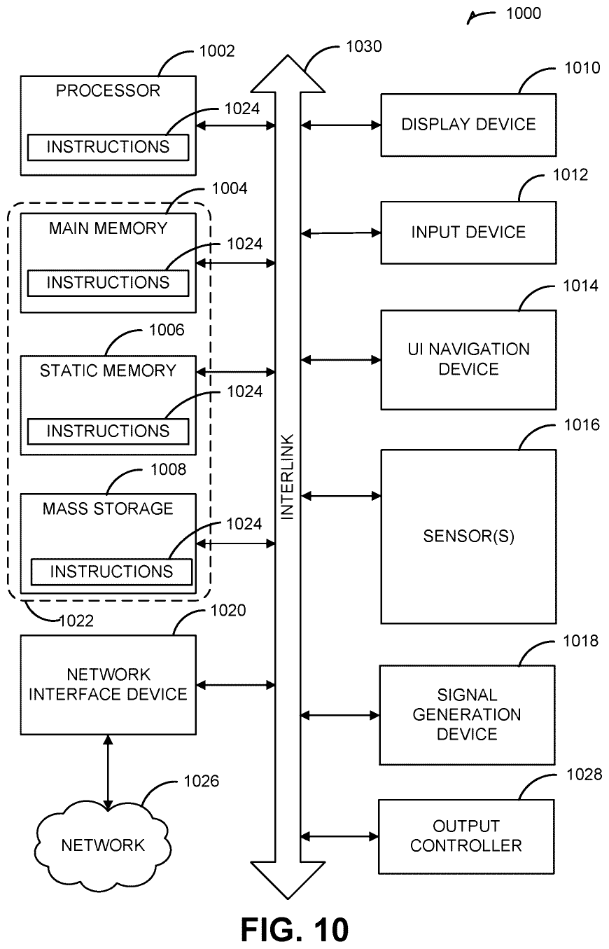

FIG. 10 illustrates a block diagram of an example comprising a machine 1000 upon which any one or more of the techniques (e.g., methodologies) discussed herein may be performed. Machine 1000 (e.g., computer system) may include a hardware processor 1002 (e.g., a central processing unit (CPU), a graphics processing unit (GPU), a hardware processor core, or any combination thereof), a main memory 1004 and a static memory 1006, connected via an interlink 1030 (e.g., link or bus), as some or all of these components may constitute hardware for systems or related implementations discussed above.

Generally, the hardware processor 1002 may, for example, include at least one of a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), a Tensor Processing Unit (TPU), a Neural Processing Unit (NPU), a Vision Processing Unit (VPU), a Machine Learning Accelerator, an Artificial Intelligence Accelerator, an Application Specific Integrated Circuit (ASIC), a Field Programmable Gate Array (FPGA), a Radio-Frequency Integrated Circuit (RFIC), a Neuromorphic Processor, a Quantum Processor, or any combination thereof. A processor circuit may further be a multi-core processor having two or more independent processors (sometimes referred to as “cores”) that may execute instructions contemporaneously. Multi-core processors contain multiple computational cores on a single integrated circuit die, each of which can independently execute program instructions in parallel. Parallel processing on multi-core processors may be implemented via architectures like superscalar, VLIW, vector processing, or SIMD that allow each core to run separate instruction streams concurrently. A processor circuit may be emulated in software, running on a physical processor, as a virtual processor or virtual circuit. The virtual processor may behave like an independent processor but is implemented in software rather than hardware.

Specific examples of main memory 1004 include Random Access Memory (RAM), and semiconductor memory devices, which may include storage locations in semiconductors such as registers. Specific examples of static memory 1006 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; or optical media such as CD-ROM and DVD-ROM disks.

The machine 1000 may further include a display device 1010, an input device 1012 (e.g., a keyboard), and a user interface (UI) navigation device 1014 (e.g., a mouse). In an example, the display device 1010, input device 1012, and UI navigation device 1014 may be a touch-screen display. The machine 1000 may include a mass storage device 1008 (e.g., drive unit), a signal generation device 1018 (e.g., a speaker), a network interface device 1020, and one or more sensors 1016, such as a global positioning system (GPS) sensor, compass, accelerometer, or some other sensor. The machine 1000 may include an output controller 1028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The mass storage device 1008 may comprise a machine-readable medium 1022 on which is stored one or more sets of data structures or instructions 1024 (e.g., software) embodying or utilized by any one or more of the techniques or functions described herein. The instructions 1024 may also reside, completely or at least partially, within the main memory 1004, within static memory 1006, or within the hardware processor 1002 during execution thereof by the machine 1000. In an example, one or any combination of the hardware processor 1002, the main memory 1004, the static memory 1006, or the mass storage device 1008 comprises a machine readable medium.

Specific examples of machine-readable media include, one or more of non-volatile memory, such as semiconductor memory devices (e.g., EPROM or EEPROM) and flash memory devices; magnetic disks, such as internal hard disks and removable disks; magneto-optical disks; RAM; or optical media such as CD-ROM and DVD-ROM disks. While the machine-readable medium is illustrated as a single medium, the term “machine readable medium” may include a single medium or multiple media (e.g., a centralized or distributed database, or associated caches and servers) configured to store the one or more instructions 1024.

An apparatus of the machine 1000 includes one or more of a hardware processor 1002 (e.g., a central processing unit (CPU), a graphics processing unit (GPU), a hardware processor core, or any combination thereof), a main memory 1004 and a static memory 1006, sensors 1016, network interface device 1020, antennas, a display device 1010, an input device 1012, a UI navigation device 1014, a mass storage device 1008, instructions 1024, a signal generation device 1018, or an output controller 1028. The apparatus may be configured to perform one or more of the methods or operations disclosed herein.

The term “machine readable medium” includes, for example, any medium that is capable of storing, encoding, or carrying instructions for execution by the machine 1000 and that cause the machine 1000 to perform any one or more of the techniques of the present disclosure or causes another apparatus or system to perform any one or more of the techniques, or that is capable of storing, encoding or carrying data structures used by or associated with such instructions. Non-limiting machine-readable medium examples include solid-state memories, optical media, or magnetic media. Specific examples of machine-readable media include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); or optical media such as CD-ROM and DVD-ROM disks. In some examples, machine readable media includes non-transitory machine-readable media. In some examples, machine readable media includes machine readable media that is not a transitory propagating signal.

The instructions 1024 may be transmitted or received, for example, over a communications network 1026 using a transmission medium via the network interface device 1020 utilizing any one of a number of transfer protocols (e.g., frame relay, internet protocol (IP), transmission control protocol (TCP), user datagram protocol (UDP), hypertext transfer protocol (HTTP), etc.). Example communication networks include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®), IEEE 802.15.4 family of standards, a Long Term Evolution (LTE) 4G or 5G family of standards, a Universal Mobile Telecommunications System (UMTS) family of standards, peer-to-peer (P2P) networks, satellite communication networks, among others.

In an example, the network interface device 1020 includes one or more physical jacks (e.g., Ethernet, coaxial, or other interconnection) or one or more antennas to access the communications network 1026. In an example, the network interface device 1020 includes one or more antennas to wirelessly communicate using at least one of single-input multiple-output (SIMO), multiple-input multiple-output (MIMO), or multiple-input single-output (MISO) techniques. In some examples, the network interface device 1020 wirelessly communicates using Multiple User MIMO techniques. The term “transmission medium” shall be taken to include any intangible medium that is capable of storing, encoding or carrying instructions for execution by the machine 1000, and includes digital or analog communications signals or other intangible medium to facilitate communication of such software.

### Various Notes

Each of the non-limiting aspects above can stand on its own or can be combined in various permutations or combinations with one or more of the other aspects or other subject matter described in this document.

The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc., are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Such instructions can be read and executed by one or more processors to enable performance of operations comprising a method, for example. The instructions are in any suitable form, such as but not limited to source code, compiled code, interpreted code, executable code, static code, dynamic code, and the like. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A machine-implemented method for performing an eddy current measurement using matrix capture, the method comprising:
for elements in an eddy current array (ECA) sensor:
generating an excitation signal and routing the excitation signal to a selected transmit element amongst the elements; and
receiving and digitizing eddy current measurements from respective receive elements from amongst the elements in response to the excitation signal; and
constructing a synthetic measurement by aggregating received eddy current measurements for different transmit-receive pairs of elements including applying gain factors based on a transmit element index and a receive element index.

2. The machine-implemented method of claim 1, wherein respective gain factors comprise a product of a gain factor corresponding to the transmit element index and a gain factor corresponding to the receive element index.

3. The machine-implemented method of claim 1, wherein the gain factors are defined uniquely based on both the transmit element index and the receive element index.

4. The machine-implemented method of claim 1, wherein the gain factors are parameterized using at least one parameter.

5. The machine-implemented method of claim 4, comprising applying a global gain compensation to the synthetic measurement using the at least one parameter.

6. The machine-implemented method of claim 4, wherein at least one parameter used to parameterize the gain factors comprises an angular skew parameter corresponding to a synthetic sensor orientation.

7. The machine-implemented method of claim 1, comprising applying lift-off compensation to the synthetic measurement.

8. The machine-implemented method of claim 7, wherein applying the lift-off compensation comprises constructing a synthetic lift-off measurement by aggregating the received eddy current measurements for the different transmit-receive pairs of sensing and applying different gain factors than are used for constructing the synthetic measurement.

9. The machine-implemented method of claim 1, wherein the aggregating received eddy current measurements comprises performing a summation, wherein terms in the summation corresponding to different received eddy current measurements scaled by corresponding gain factors.

10. The machine-implemented method of claim 1, wherein the eddy current measurements are complex-valued.

11. The machine-implemented method of claim 1, wherein the different transmit-receive pairs include permutations where a same element in the ECA sensor is used as both a transmit element and a receive element contemporaneously.

12. The machine-implemented method of claim 11, wherein the receiving eddy current measurements where the same element in the ECA sensor is used as both the transmit element and the receive element comprises using an impedance measurement.

13. The machine-implemented method of claim 1, comprising establishing a series of synthetic measurements corresponding to different times.

14. The machine-implemented method of claim 13, comprising generating a presentation plotting the series of synthetic measurements parametrically in an impedance plane view.

15. The machine-implemented method of claim 13, comprising generating a presentation plotting a scalar values derived from the series of synthetic measurements as a time-series strip-chart.

16. The machine-implemented method of claim 1, wherein the constructing the synthetic measurement comprises aggregating received eddy current measurements for all available transmit-receive pair permutations.

17. A system for performing an eddy current measurement using matrix capture, the system comprising:
a transmitter circuit configured to generate an excitation signal;
a receiver circuit configured to receive an eddy current measurement;
a multiplexer configured to selectively route the excitation signal to a selected sensor in an eddy current array (ECA) sensor;
a processor circuit communicatively coupled with the transmitter circuit, the receiver circuit, and the multiplexer circuit; and
a memory circuit communicatively coupled with the processor circuit, the memory circuit comprising instructions that, when executed by the processor circuit, cause the system to:
for elements in the eddy current array (ECA) sensor:
generate the excitation signal and route the excitation signal to a selected transmit element amongst the elements; and
receive and digitize eddy current measurements from respective receive elements from amongst the elements in response to the excitation signal; and
construct a synthetic measurement by aggregating received eddy current measurements for different transmit-receive pairs of elements including applying gain factors based on a transmit element index and a receive element index.

18. The system of claim 17, further comprising a bridge circuit configured to perform an impedance measurement.

19. The system ofany of claim 17, further comprising the ECA sensor.

20. The system of claim 17, wherein the ECA sensor comprises a flexible planar sensor comprising at least four sensor coil elements.
